(19) United States
(12) Patent Application Publication
(10) Pub. No.: US 2026/0258812 A1
(43) Pub. Date: Sep. 3, 2026

(54) SERRATED IMPELLER BLADES

(71) Applicant: Danfoss A/S, Nordborg (DK)

(72) Inventors: Jin Yan, Tallahassee, FL (US); Brenden Richman, Tallahassee, FL (US)

(21) Appl. No.: 18/877,563

(22) PCT Filed: May 25, 2023
(86) PCT No.: PCT/US2023/023528

§ 371 Date: Dec. 20, 2024

Related U.S. Application Data
(60) Provisional application No. 63/358,294, filed on Jul. 5, 2022.

(51) Int. Cl. F04D 29/30; F04D 17/10; F04D 29/66

(52) U.S. Cl. CPC F04D 29/30; F04D 17/10; F04D 29/663; F05D 2250/183

(57) ABSTRACT

A refrigerant compressor includes an impeller including a blade having a trailing edge having one or more serrations.

### CROSS-REFERENCED TO RELATED APPLICATION

This application claims priority to International Application No. PCT/US2023/023528, filed May 25, 2024, which claims priority to U.S. Provisional Application No. 63/358,294, which was filed on Jul. 5, 2022.

### BACKGROUND

Refrigerant compressors are used to circulate refrigerant in a chiller via a refrigerant loop. Refrigerant loops are known to include a compressor, a condenser, an expansion device, and an evaporator. The compressor compresses the fluid, which then travels to the condenser, which in turn cools and condenses the fluid. The refrigerant then goes to the expansion device, which decreases the pressure of the fluid, and to the evaporator, where the fluid is vaporized, completing a refrigeration cycle.

Many refrigerant compressors are centrifugal compressors and have an electric motor that drives at least one impeller to compress refrigerant. Fluid flows into the impeller in an axial direction, and is expelled radially from the impeller.

### SUMMARY

A refrigerant compressor according to an example of this disclosure includes an impeller including a blade having a trailing edge having one or more serrations.

In a further example of the foregoing, the impeller includes a plurality of main blades and first and second splitter blades between adjacent main blades. Each of the main blades and the first and second splitter blades includes a trailing edge having one or more serrations.

In a further example of any of the foregoing, the first splitter blade extends a first length between a leading edge and a trailing edge thereof, and the second splitter blade extends a second length between a leading edge and a trailing edge thereof. The first length is greater than the second length. Each main blade extends a third length between a leading edge and a trailing edge thereof, and the third length is greater than the first and second lengths.

In a further example of any of the foregoing, the leading edges of the first splitter blade, the second splitter blade, and each main blade are staggered relative to one another. The trailing edges of the first splitter blade, the second splitter blade, and each main blade are aligned relative to one another and are provided at a common radial distance from a rotational axis of the impeller and are coextensive with an exit of the impeller.

In a further example of any of the foregoing, the one or more serrations are rounded sawtooth serrations.

In a further example of any of the foregoing, the one or more serrations each include first and second curved surfaces that converge to a sharp tip.

In a further example of any of the foregoing, the first and second curved surfaces are convex.

In a further example of any of the foregoing, the one or more serrations includes a plurality of serrations, and the first and second curved surfaces of adjacent ones of the plurality of serrations meet at a point radially inward of the sharp tips and form spaces axially therebetween.

In a further example of any of the foregoing, the impeller includes a plurality of blades, and every other blade of the plurality of blades includes a trailing edge having one or more serrations, and the plurality of blades other than the every other blades do not include serrations.

In a further example of any of the foregoing, the blade includes three serrations.

A refrigerant system according to an example of this disclosure includes a main refrigerant loop including a compressor, a condenser, an evaporator, and an expansion device. The compressor includes an impeller including a blade having a trailing edge having one or more serrations.

In a further example of the foregoing, the impeller includes a plurality of main blades and first and second splitter blades between adjacent main blades, and each of the main blades and the first and second splitter blades includes a trailing edge having one or more serrations.

In a further example of any of the foregoing, the first splitter blade extends a first length between a leading edge and a trailing edge thereof. The second splitter blade extends a second length between a leading edge and a trailing edge thereof. The first length is greater than the second length. Each main blade extends a third length between a leading edge and a trailing edge thereof, and the third length is greater than the first and second lengths.

In a further example of any of the foregoing, the leading edges of the first splitter blade, the second splitter blade, and each main blade are staggered relative to one another. The trailing edges of the first splitter blade, the second splitter blade, and each main blade are aligned relative to one another and are provided at a common radial distance from a rotational axis of the impeller and are coextensive with an exit of the impeller.

In a further example of any of the foregoing, the one or more serrations are rounded sawtooth serrations.

In a further example of any of the foregoing, one or more serrations each include first and second curved surfaces that converge to a sharp tip.

In a further example of any of the foregoing, the first and second curved surfaces are convex.

In a further example of any of the foregoing, one or more serrations include a plurality of serrations, and the first and second curved surfaces of adjacent ones of the plurality of serrations meet at a point radially inward of the sharp tips and form spaces axially therebetween.

In a further example of any of the foregoing, the impeller includes a plurality of blades, and every other blade of the plurality of blades includes a trailing edge having one or more serrations, and the plurality of blades other than the every other blades do not include serrations.

A refrigerant compressor according to an example of this disclosure includes an impeller, which includes a plurality of main blades and first and second splitter blades between adjacent main blades. Each of the main blades and the first and second splitter blades includes a trailing edge having a plurality of sawtooth serrations. The first splitter blade extends a first length between a leading edge and a trailing edge thereof. The second splitter blade extends a second length between a leading edge and a trailing edge. The first length is greater than the second length. Each main blade extends a third length between a leading edge and a trailing edge thereof. The third length is greater than the first and second lengths. The leading edges of the first splitter blade, the second splitter blade, and each main blade are staggered relative to one another. The trailing edges of the first splitter blade, the second splitter blade, and each main blade are aligned relative to one another and are provided at a common radial distance from a rotational axis of the impeller and are coextensive with an exit of the impeller. The plurality of serrations each include first and second convex surfaces that converge to a sharp tip, and the first and second convex surfaces of adjacent ones of the plurality of serrations meet at a point radially inward of the sharp tips and form spaces axially therebetween.

These and other features may be best understood from the following specification and drawings, the following of which is a brief description.

### BRIEF DESCRIPTION OF THE DRAWINGS

FIG. 1 schematically illustrates a refrigerant system.

FIG. 2 is a schematic, partial cross-sectional view of a compressor.

FIG. 3 is an axial end view of an example impeller.

FIG. 4 is a cross-sectional illustration of a portion of the impeller, and in particular illustrates an exemplary blade arrangement, including a main blade, a first splitter blade, and a second splitter blade.

FIG. 5 illustrates a radial view of the impeller.

FIG. 6 schematically illustrates flow vortices from any one of the trailing edges of the example impeller.

FIG. 7 illustrates another example impeller.

FIG. 8 schematically illustrates flow vortices from any one of the trailing edges of the example impeller of FIG. 7.

FIG. 9 schematically illustrates another example trailing edge.

FIG. 10 illustrates a portion of another example impeller.

FIG. 11 illustrates another example impeller.

### DETAILED DESCRIPTION

This disclosure relates generally to refrigerant compressors, and more particularly to impeller blades of a refrigerant compressor. The systems and methods disclosed herein have been found to decrease the noise output of refrigerant compressors.

FIG. 1 illustrates a refrigerant system 10. The refrigerant system 10 includes a main refrigerant loop, or circuit, 12 in communication with a compressor 14, a condenser 16, an evaporator 18, and an expansion device 20. This refrigerant system 10 may be used in a chiller, for example. In that example, a cooling tower may be in fluid communication with the condenser 16. While a particular example of the refrigerant system 10 is shown, this application extends to other refrigerant system configurations, including configurations that do not include a chiller. For instance, the main refrigerant loop 12 can include an economizer downstream of the condenser 16 and upstream of the expansion device 20.

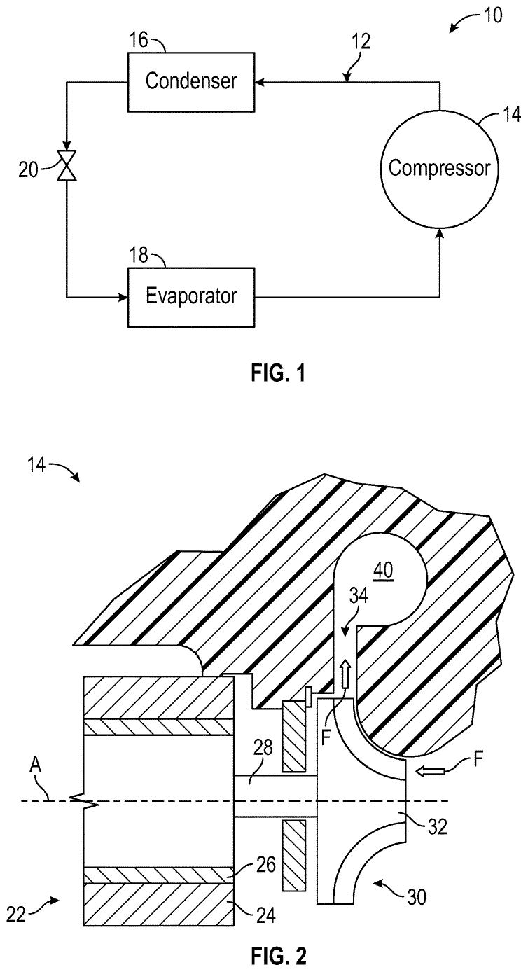

FIG. 2 illustrates, in cross-section, a portion of the compressor 14. The compressor 14 includes an electric motor 22 having a stator 24 arranged radially outside of a rotor 26. The rotor 26 is connected to a shaft 28, which rotates to drive at least one compression stage 30 of the compressor 14, which in this example includes at least one impeller 32. The compressor 14 may include multiple compression stages.

The shaft 28 and impeller 32 are rotatable by the electric motor 22 about an axis A to compress refrigerant F. The terms axial, radial, and circumferential in this disclosure are used relative to the axis A. The shaft 28 may be rotatably supported by a plurality of bearing assemblies, which in some examples are magnetic bearing assemblies.

During operation of the compressor 14, refrigerant F flows axially toward the impeller 32 and is expelled radially outwardly to a diffuser 34 downstream of the impeller 32. The diffuser 34 is arranged radially between the outlet of the impeller 32 and a volute 40. The volute 40 may be in fluid communication with the condenser 16 or another compression stage of the compressor 14.

FIG. 3 is an axial end view of the example impeller 32 along the axis A. The impeller 32 is configured to rotate in a counter-clockwise direction, in this example. The impeller 32 is not shrouded in this example. However, the impeller 32 could be shrouded.

The impeller 32 includes a plurality of blades projecting radially outward from a hub 42. In particular, the impeller 32 includes a plurality of main blades 44 spaced-apart from one another circumferentially about the axis A. Two of the main blades 44 are labeled in FIG. 3. The impeller 32 includes seven total main blades 44 in the example of FIG. 3. This disclosure extends to impellers that include another number of main blades 44.

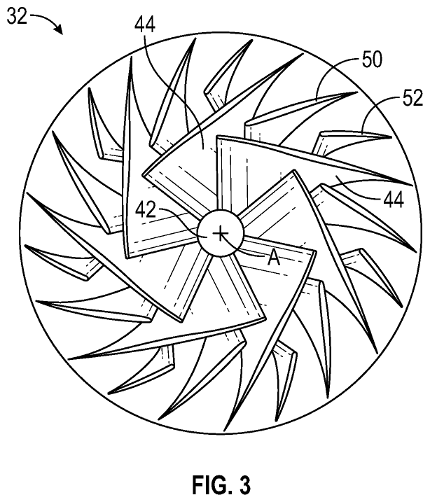

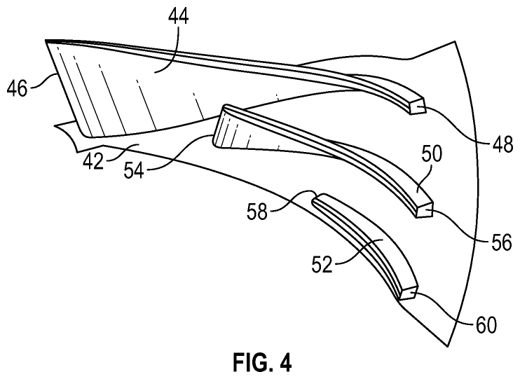

With reference to FIGS. 4 and 5, the main blades 44 extend from a leading edge 46 adjacent an inlet to the impeller 32 to a trailing edge 48 adjacent an outlet of the impeller 32. The main blades 44 are configured to receive a flow of fluid flowing in an axial direction and to turn that flow such that it is radially expelled from the impeller 32.

Between each of the adjacent main blades 44, the impeller 32 includes first and second splitter blades 50, 52, in this example. The arrangement of a main blade 44, a first splitter blade 50, and a second splitter blade 52 is continued and repeated about the axis A.

The first splitter blade 50 extends between a leading edge 54 and a trailing edge 56. Likewise, the second splitter blade 52 extends between a leading edge 58 and a trailing edge 60.

The first and second splitter blades 50, 52 are shorter than the main blades 44. Specifically, a length of the first and second splitter blades 50, 52 between the respective leading and trailing edges is less than that of the main blades 44. Further, the second splitter blades 52 are shorter than the first splitter blades 50.

The main blades 44 and first and second splitter blades 50, 52 are staggered relative to one another along the impeller 32. In particular, with reference to FIG. 5, the leading edges 46, 54, 58 are spaced-apart from one another while the trailing edges 48, 56, 60 are aligned. In particular, the trailing edges 48, 56, 60 are provided at a common distance, namely a radial distance, away from the axis A. The trailing edges 48, 56, 60 are coextensive with the exit of the impeller 32, in this example. Other configurations of impellers, including those with or without splitter blades, will benefit from this disclosure.

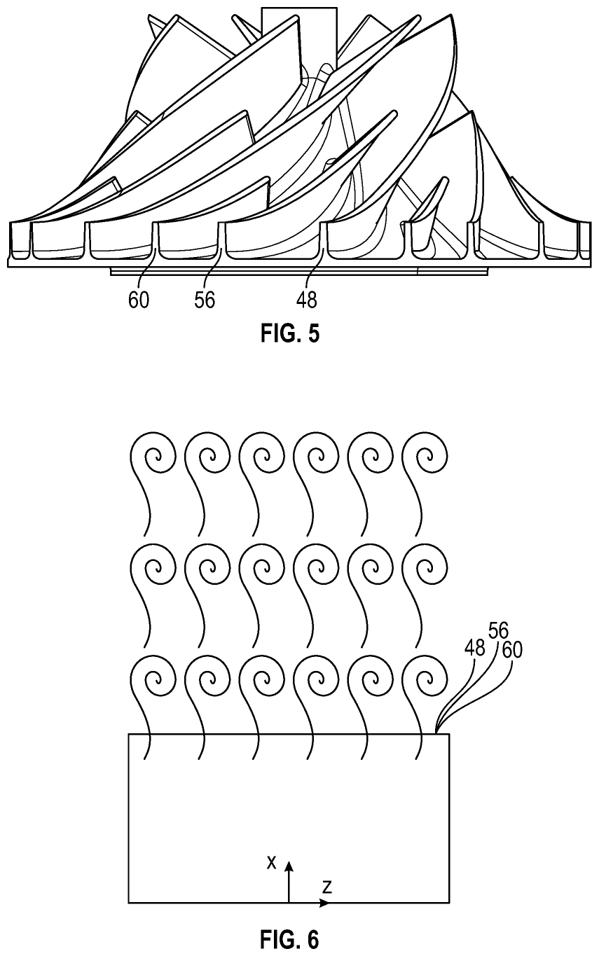

FIG. 6 schematically illustrates flow vortices from any one of the trailing edges 48, 56, 60. With straight trailing edges, Applicant has realized that vortices that are created in the flow follow the same direction, persist, and take long to dissipate, resulting in acoustic noise from the fluid flowing over the impeller blades.

FIG. 7 illustrates another example impeller 132. It should be understood that like reference numerals identify corresponding or similar elements throughout the several drawings. The impeller 132 is substantially similar to the impeller 32 in some examples, except that trailing edges 148, 156, 160 include one or more serrations 162. In the example shown, all trailing edges 148, 156, 160 include one or more serrations 162. In other examples, one or more trailing edges 148, 156, 160 may not be serrated, and may have straight edges for example. In some examples, as shown in the FIG. 11 example impeller 432, every other edge includes one or more serrations 462, and the other edges do not include serrations. In some examples, some other select number or pattern of edges includes one or more serrations 162. Although three serrations 162 are shown on the example edges, more or fewer serrations may be utilized in some examples.

The serrations 162 can be implemented at any blade trailing edge in a centrifugal, refrigerant compressor. At any of these locations, the geometry will change the speed and trajectory of the flow which will decrease its level of turbulence. Several serrations can be implemented at any or each blade trailing edge in some examples. With these serrations in place, vortices created by a blade's straight trailing edge can be mitigated and thus reduce the acoustic level of the fluid flow over the blade, as discussed further below. Although an example impeller 132 is shown, other configurations of impellers, including those with or without splitter blades, will benefit from this disclosure.

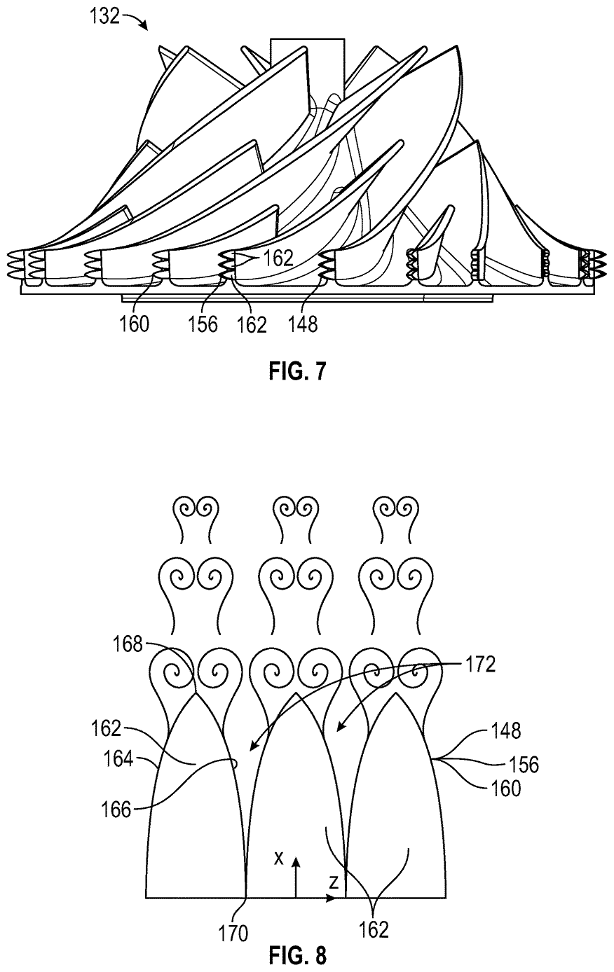

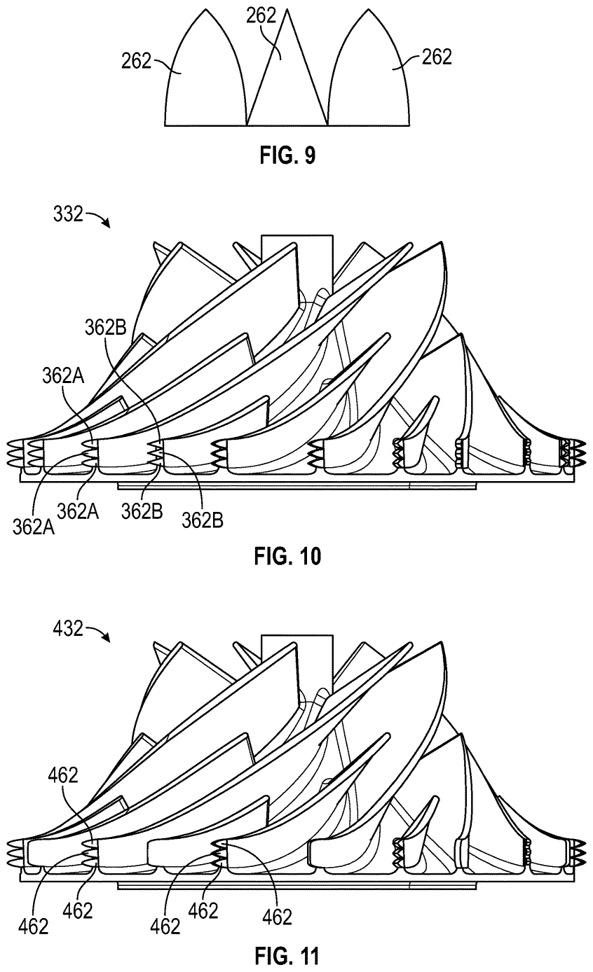

FIG. 8 schematically illustrates flow vortices from any one of the trailing edges 148, 156, 160. The example serrations 162 are rounded sawtooth serrations, but other shapes and contours may be utilized. Each example serration 162 includes a first curved surface 164 and a second curved surface 166 converging to a sharp tip 168. In some examples, as shown, the surfaces 164, 166 are convex. Other curvatures are contemplated. In some examples, as shown, the curved surfaces 164, 166 of adjacent serrations 162 meet at a point 170 radially inward of the tips 168 and form spaces 172 axially therebetween. In some examples, the surfaces 164, 166 may be straight instead of curved. In the example shown, each of the three serrations 162 is a rounded sawtooth serration. In other examples, as shown schematically in FIG. 9, one edge may include two or more serrations 262 of different geometries. In some examples, as shown in FIG. 10, a first edge of the impeller 332 may include a first shape, number, and/or pattern of serrations 362A, and a second edge of the impeller 332 may include a different shape, number, and/or pattern of serrations 362B. That is, the shape, number, and/or pattern of serrations may be varied across blade edges of the same impeller.

As shown schematically, the serrated edges 148, 156, 160 decrease the acoustic level of a given centrifugal, refrigerant compressor system by decreasing the number and size of vortices that are created from turbulent flow at the trailing edge of an impeller blade. When compared to a straight trailing edge on a blade, as seen in FIG. 6, the serrated edges can decrease noise levels through vortex shedding. This is due to the serrations, such as the rounded sawtooth serrations, decreasing the number and size of vortices formed at the trailing edge of an impeller blade. Vortices are formed in opposing directions at the serrated trailing edge and begin to cancel each other out, this vortex shedding being shown schematically in FIG. 8. The design uses its flow geometry to decrease the number and size of vortices at the trailing edge of an impeller blade and thus decrease the level of noise created by the impeller 132.

The example serrated edges 148, 156, 160 implement a trailing edge geometry on an impeller for centrifugal, refrigerant compressors. The examples disclosed change the flow characteristics of flow at the trailing edge of the blade to decrease the number and size of vortices created in the flow.

The foregoing description shall be interpreted as illustrative. A worker of ordinary skill in the art would understand that certain modifications could come within the scope of this disclosure. Various examples of the disclosure have been described. Any combination of the described systems, operations, or functions is contemplated. It is possible to use some of the components or features from any of the examples in combination with features or components from any of the other examples.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A refrigerant compressor, comprising:
an impeller including a blade having a trailing edge having one or more serrations.

2. The compressor of claim 1, wherein
the impeller includes a plurality of main blades and first and second splitter blades between adjacent main blades, and
each of the main blades and the first and second splitter blades includes a trailing edge having one or more serrations.

3. The compressor of claim 2, wherein
the first splitter blade extends a first length between a leading edge and a trailing edge thereof,
the second splitter blade extends a second length between a leading edge and a trailing edge thereof,
the first length is greater than the second length, each main blade extends a third length between a leading edge and a trailing edge thereof, and
the third length is greater than the first and second lengths.

4. The compressor of claim 3, wherein
the leading edges of the first splitter blade, the second splitter blade, and each main blade are staggered relative to one another, and
the trailing edges of the first splitter blade, the second splitter blade, and each main blade are aligned relative to one another and are provided at a common radial distance from a rotational axis of the impeller and are coextensive with an exit of the impeller.

5. The compressor of claim 1, wherein the one or more serrations are rounded sawtooth serrations.

6. The compressor of claim 5, wherein the one or more serrations each include first and second curved surfaces that converge to a sharp tip.

7. The compressor of claim 6, wherein the first and second curved surfaces are convex.

8. The compressor of claim 6, wherein the one or more serrations includes a plurality of serrations, and the first and second curved surfaces of adjacent ones of the plurality of serrations meet at a point radially inward of the sharp tips and form spaces axially therebetween.

9. The compressor of claim 1, wherein the impeller includes a plurality of blades, and every other blade of the plurality of blades includes a trailing edge having one or more serrations, and the plurality of blades other than the every other blades do not include serrations.

10. The compressor of claim 1, wherein the blade includes three serrations.

11. A refrigerant system, comprising:
a main refrigerant loop including a compressor, a condenser, an evaporator, and an expansion device, wherein the compressor includes an impeller including a blade having a trailing edge having one or more serrations.

12. The system of claim 11, wherein
the impeller includes a plurality of main blades and first and second splitter blades between adjacent main blades, and
each of the main blades and the first and second splitter blades includes a trailing edge having one or more serrations.

13. The system of claim 12, wherein
the first splitter blade extends a first length between a leading edge and a trailing edge thereof,
the second splitter blade extends a second length between a leading edge and a trailing edge thereof,
the first length is greater than the second length, each main blade extends a third length between a leading edge and a trailing edge thereof, and
the third length is greater than the first and second lengths.

14. The system of claim 13, wherein
the leading edges of the first splitter blade, the second splitter blade, and each main blade are staggered relative to one another, and
the trailing edges of the first splitter blade, the second splitter blade, and each main blade are aligned relative to one another and are provided at a common radial distance from a rotational axis of the impeller and are coextensive with an exit of the impeller.

15. The system of claim 11, wherein the one or more serrations are rounded sawtooth serrations.

16. The system of claim 15, wherein the one or more serrations each include first and second curved surfaces that converge to a sharp tip.

17. The system of claim 16, wherein the first and second curved surfaces are convex.

18. The system of claim 16, wherein the one or more serrations includes a plurality of serrations, and the first and second curved surfaces of adjacent ones of the plurality of serrations meet at a point radially inward of the sharp tips and form spaces axially therebetween.

19. The system of claim 11, wherein the impeller includes a plurality of blades, and every other blade of the plurality of blades includes a trailing edge having one or more serrations, and the plurality of blades other than the every other blades do not include serrations.

20. A refrigerant compressor, comprising:
an impeller including a plurality of main blades and first and second splitter blades between adjacent main blades, each of the main blades and the first and second splitter blades includes a trailing edge having a plurality of sawtooth serrations, wherein
the first splitter blade extends a first length between a leading edge and a trailing edge thereof,
the second splitter blade extends a second length between a leading edge and a trailing edge thereof,
the first length is greater than the second length, each main blade extends a third length between a leading edge and a trailing edge thereof,
the third length is greater than the first and second lengths, the leading edges of the first splitter blade, the second splitter blade, and each main blade are staggered relative to one another,
the trailing edges of the first splitter blade, the second splitter blade, and each main blade are aligned relative to one another and are provided at a common radial distance from a rotational axis of the impeller and are coextensive with an exit of the impeller, and
the plurality of serrations each include first and second convex surfaces that converge to a sharp tip, and the first and second convex surfaces of adjacent ones of the plurality of serrations meet at a point radially inward of the sharp tips and form spaces axially therebetween.
